(19) United States
(12) Patent Application Publication
(10) Pub. No.: US 2023/0063309 A1
(43) Pub. Date: Mar. 2, 2023

(54) METHOD FOR PROCESSING HUMAN BODY IMAGE AND ELECTRONIC DEVICE

(71) Applicant: Beijing Dajia Internet Information Technology Co., Ltd., Beijing (CN)

(72) Inventors: Xiaokun LIU, Beijing (CN); Wenyu QIN, Beijing (CN)

(21) Appl. No.: 18/047,603

(22) Filed: Oct. 18, 2022

Related U.S. Application Data
(63) Continuation of application No. PCT/CN2020/129901, filed on Nov. 18, 2020.

(30) Foreign Application Priority Data
Jun. 16, 2020 (CN) 202010547139.3

(51) Int. Cl. G06T 5/00; G06T 7/11; G06T 5/20; G06T 7/136; G06T 7/90; G06T 3/40; G06T 5/50; G06V 40/16

(52) U.S. Cl. CPC G06T 5/005; G06T 7/11; G06T 5/20; G06T 7/136; G06T 7/90; G06T 3/40; G06T 5/50; G06V 40/171; G06T 2207/20221; G06T 2207/30201

(57) ABSTRACT

Provided is a method for processing a human body images, including: dividing an initial candidate region in the human body image into a blemished skin region and a non-blemished skin region; acquiring an intermediate candidate region by linearly fusing the blemished skin region and the non-blemished skin region with a filtered blemished region and a filtered non-blemished region respectively; acquiring a target candidate region by performing linear light superimposition on the intermediate candidate region and the initial candidate region; and outputting a target image containing the target candidate region.

### CROSS-REFERENCE TO RELATED APPLICATION

This application is a continuation application of international application No. PCT/CN2020/129901, filed on Nov. 18, 2020, which claims priority to Chinese Patent Application No. 202010547139.3, filed on Jun. 16, 2020, the disclosures of which are herein incorporated by reference in their entireties.

### TECHNICAL FIELD

The present disclosure relates to the field of image processing, and in particular, to a method for processing a human body image and an electronic device.

### BACKGROUND

With the development of image technologies, terminal devices can beautify images captured during live streaming or shooting. For example, terminal devices can remove facial blemishes such as acne marks, moles, and stains in the images.

### SUMMARY

Embodiments of the present disclosure provide a method for processing a human body image and an electronic device, and technical solutions according to the embodiments of the present disclosure are as follows:

In one aspect, a method for processing a human body image is provided. The method includes: dividing an initial candidate region in the human body image into a blemished skin region and a non-blemished skin region, the initial candidate region being a skin region which does not contain a specified region; acquiring an intermediate candidate region by linearly fusing the blemished skin region and the non-blemished skin region with a filtered blemished region and a filtered non-blemished region respectively; acquiring a target candidate region by performing linear light superimposition on the intermediate candidate region and the initial candidate region; and outputting a target image containing the target candidate region.

In another aspect, an electronic device is provided. The electronic device includes: a memory configured to store executable instructions; and a processor configured to load and execute the executable instructions stored in the memory; wherein the processor, when loading and executing the executable instructions is caused to perform: dividing an initial candidate region in the human body image into a blemished skin region and a non-blemished skin region, the initial candidate region being a skin region which does not contain a specified region; acquiring an intermediate candidate region by linearly fusing the blemished skin region and the non-blemished skin region with a filtered blemished region and a filtered non-blemished region respectively; acquiring a target candidate region by performing linear light superimposition on the intermediate candidate region and the initial candidate region; and outputting a target image containing the target candidate region.

In another aspect, a computer-readable storage medium is provided, wherein one or more instructions in the computer-readable storage medium, when executed by an electronic device, cause the electronic device to perform: dividing an initial candidate region in the human body image into a blemished skin region and a non-blemished skin region, the initial candidate region being a skin region which does not contain a specified region; acquiring an intermediate candidate region by linearly fusing the blemished skin region and the non-blemished skin region with a filtered blemished region and a filtered non-blemished region respectively; acquiring a target candidate region by performing linear light superimposition on the intermediate candidate region and the initial candidate region; and outputting a target image containing the target candidate region.

### BRIEF DESCRIPTION OF THE DRAWINGS

FIG. 1 is a schematic diagram of a received human body image to be processed in some embodiments of the present disclosure;

FIG. 2 is a schematic diagram of an image acquired after processing a human body image using prior art technology;

FIG. 3 is a schematic flowchart of image optimization in some embodiments of the present disclosure;

FIG. 4 is a schematic diagram of determining a standard facial feature point image in some embodiments of the present disclosure;

FIG. 5 is a schematic diagram of a correspondingly established standard mask image in some embodiments of the present disclosure;

FIG. 6 is a schematic diagram of a first mask image in some embodiments of the present disclosure;

FIG. 7 is a schematic diagram of a human body image to be processed after optimization in some embodiments of the present disclosure;

FIG. 8 is a schematic diagram of a logical structure of an electronic device executing image optimization in some embodiments of the present disclosure; and

FIG. 9 is a schematic diagram of a physical structure of an electronic device executing image optimization in some embodiments of the present disclosure.

### DETAILED DESCRIPTION

With the development of image technologies, terminal devices can beautify the images captured during live streaming or shooting, for example, can remove facial blemishes such as acne marks, moles, and stains in the images. In the related art, the processing of the facial blemishes involves the following modes:

In the first mode, a specific acne removal algorithm is adopted to remove the facial blemishes such as the acne marks.

However, due to computational complexity of the acne removal algorithm, removal of the facial blemishes requires a certain amount of processing time. Currently, the first mode is only used in picture shooting, and cannot be applied to live streaming or videos in real time.

In the second mode, a skin grinding mode is adopted, and the facial blemishes are removed by adjusting the processing level of a skin grinding operation.

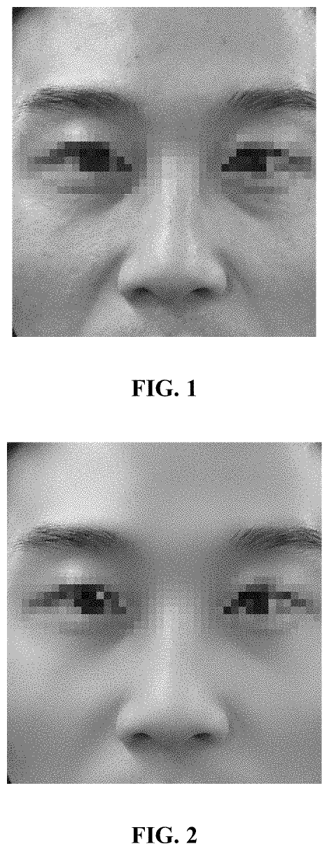

However, referring to FIG. 1 and FIG. 2, during the live streaming or videos in real time, the original image as shown in FIG. 1 is captured. In the case that the skin grinding level of the image is not adjusted, only slight processing is performed on the facial blemishes. To remove the facial blemishes, it is necessary to increase the skin grinding level to remove the facial blemishes. Using higher skin grinding level, skin textures are removed with removal of the facial blemishes, resulting in a processing effect as shown in FIG. 2. At the high skin grinding level, the facial skin of the processed image becomes smooth and almost pure color, and there are serious smear marks, resulting in the image that looks unreal.

In the third mode, the photoshop (PS) technology is adopted, based on a hyperbolic skin grinding method, and the image to be processed is converted into a grayscale image. In comparison, in the grayscale image, facial blemish parts are displayed as dark regions with smaller grayscale values, and normal skin regions are displayed as bright regions with larger grayscale values. Therefore, the hyperbolic skin grinding mode is adopted to make the contrast between the dark regions and the bright regions more obvious, and then the facial blemishes corresponding to the dark regions are manually removed.

However, the third mode relies on manual processing, and needs to spend a lot of time to process one picture, and the facial blemishes during live streaming or videos in real time cannot be removed.

In view of this, in the embodiments of the present disclosure, an initial candidate region in a human body image to be processed is determined, a first filter processing is performed on the human body image to be processed to acquire a first filtered image, a first filtered candidate region in the first filtered image corresponding to the initial candidate region is determined, then based on grayscale value differences between respective corresponding pixel points in the initial candidate region and the first filtered candidate region, the initial candidate region in the human body image to be processed is divided into a blemished skin region and a non-blemished skin region, then based on a determined first fusion coefficient, the blemished skin region and the non-blemished skin region are linearly fused with the corresponding regions in the first filtered candidate region, the processed blemished region and the processed non-blemished region are merged as an intermediate candidate region in the human body image to be processed, then based on grayscale value differences between respective corresponding pixel points in the initial candidate region and the intermediate candidate region, linear light superimposition processing is performed on the intermediate, candidate region to acquire a target candidate region, and the human body image to be processed containing the target candidate region is output as a target image.

In the present disclosure, a processing device capable of performing the method involved in the present disclosure includes: a server, or other terminal devices with processing capabilities, wherein the terminal devices include, but are not limited to, mobile phones, computers, shooting devices with the processing capabilities, and the like.

In the present disclosure, the initial image region that needs to be processed in the human body image to be processed is firstly determined, the parts that are not expected to be processed or the parts that need to be processed slightly in the human body image to be processed are masked respectively to acquire corresponding mask images. For example, in the cast where only the facial blemishes of a human face need to be processed, a standard mask image may be manufactured in advance for unprocessed facial organ regions and slightly processed facial organ edge regions, and different grayscale values are set for pixel points in different regions in the standard mask image, wherein the same grayscale value is set for respective pixel points in the same region, while different grayscale values are set for respective pixel points in different regions. Sizes of the grayscale values set for the pixel points in different regions represent a strength of processing degrees for the pixel points in different regions.

Further, after the human body image to be processed is acquired, a first mask image and a second mask image which correspond to the human body image to be processed are determined based on a basic mask image manufactured in advance and a skirt color detection technology, then pixel points in the first mask image and the second mask image are screened, and the region formed by the screened pixel points is determined as the initial candidate region that needs to be processed in the human body image to be processed.

At the same time, the first filter processing and second filter processing are respectively performed on the acquired human body image to be processed to acquire the corresponding first filtered image and the corresponding second filtered image. In other words, different degrees of filtering are performed on the human body image to acquire the first filtered image and the second filtered image. Next, the first filtered candidate region in the first filtered image corresponding to the initial candidate region and a second filtered candidate region corresponding to the initial candidate region in the second filtered image are determined, and then the first filtered candidate region in the first filtered image and the initial candidate region in the human body image to be processed are linearly fused to acquire the intermediate candidate region in the human body image to be processed.

Then based on grayscale difference values between respective corresponding pixel points in the initial candidate region in the human body image to be processed and in the intermediate candidate region in the human body image to be processed, the intermediate candidate region in the human body image to be processed is subjected to linear light superimposition to acquire the target candidate region, wherein the respective corresponding pixel points in the initial candidate region and the intermediate candidate region refer to respective pixel points at identical positions in the initial candidate region and the intermediate candidate region. For example, the pixel point with coordinates (10, 20) in the initial candidate region and the pixel point with coordinates (10, 20) in the intermediate candidate region are a pair of pixel points at identical positions. Further, in order to ensure realness of the output image, optionally, the human body image to be processed containing the target candidate region is linearly fused with the second filtered image to acquire the target image with a real texture.

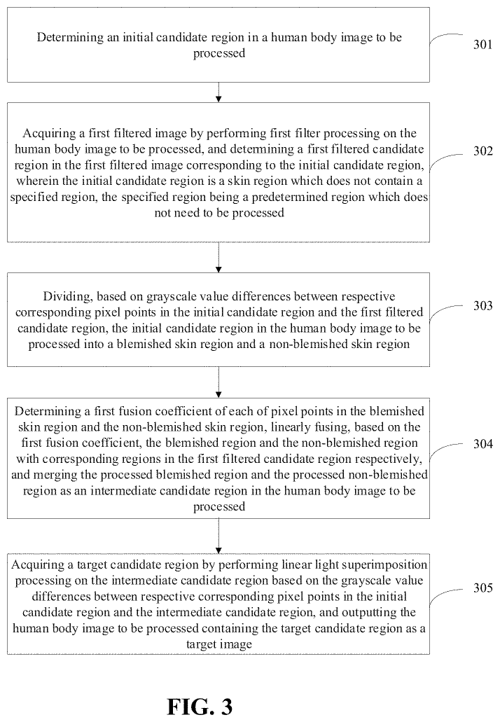

In the following, an embodiment of the present disclosure is described in detail in combination with FIG. 3. The embodiment of the present disclosure is executed by a server or other terminal devices with processing capabilities:

In S301: an initial candidate region in a human body image to be processed is determined.

After the captured human body image to be processed is acquired, the human body image to be processed is marked as InputImage, and further, the initial candidate region in the human body image to be processed is determined. In other words, the initial candidate region is determined from the human body image to be processed, the initial candidate region refers to a skin region which does not contain a specified region, and the specified region is a predetermined region which does not need to be processed.

In some embodiments, the process of determining the initial candidate region is as follows:

S1: a first mask image and a second mask image which correspond to the human body image to be processed are determined.

By adopting a skin color detection technology, the first mask image corresponding to the human body image to be processed is acquired, and a pre-configured standard mask image is subjected to twist mapping to acquire the second mask image corresponding to the human body image to be processed, wherein different grayscale values are configured for pixel points of different regions in the standard mask image, and the different grayscale values represent different predetermined processing coefficients.

In some embodiments, the human body image to be processed is firstly detected by using the skin color detection technology, a skin region and a non-skin region in the human body image to be processed are recognized, and the first mask image is acquired, in other words, the human body image is subjected to skin color detection to acquire the first mask image for distinguishing the skin region and the non-skin region in the human body image. Optionally, the first mask image is a grayscale image, and the grayscale value of each pixel point in the first mask image represents a probability value that the recognized part that is skin in the human body image to be processed at an identical relative position as the pixel point. Optionally, the first mask image is a binary image, at this point, the pixel value of each pixel point in the first mask image is either 1 or 0, for example, the pixel value 1 represents that the pixel point is in the skin region, and the pixel value 0 represents that the pixel point is in the non-skin region. For another example, the pixel value 0 represents that the pixel point is in the skin region, and the pixel value 1 represents that the pixel point is in the non-skin region.

Further, twist mapping is performed on the pre-configured standard mask image to acquire the second mask image corresponding to the human body image to be processed, wherein different grayscale values are configured for the pixel points of different regions in the standard mask image. Different grayscale values represent different predetermined processing coefficients. It should be noted that an identical grayscale value is configured for the pixel points in the same region in the standard mask image.

In some embodiments, before the second mask image is acquired, a predetermined facial feature point recognition model is adopted to recognize candidate facial feature points in the human body image to he processed. In addition, the facial feature point recognition model is adopted in advance to recognize a standard human body image, and a standard human body feature point image is acquired. Then, based on actual processing needs, unprocessed image regions are determined, for example, the regions of facial features, such as eyebrows, eyes, mouth, lying silkworm, nostrils, nose wings, jaw line, eye bags, and nasolabial folds, which are selectively determined by standard human feature points, are set as the unprocessed image regions, the grayscale values of the pixel points in the unprocessed image regions are set according to processing needs, and the standard mask image is established.

In some embodiments, in order to ensure natural transitions between the image regions that need to be processed and the unprocessed image regions while avoiding an obvious sense of separation in the unprocessed image regions when the subsequent processing of the human body image to be processed is completed, increased grayscale values are configured at edges of the image regions that need to be processed and the unprocessed image regions, thereby achieving proper processing of the edges.

In some embodiments, when the standard mask image is configured, a value between 0 and 1 is configured for the grayscale value of each pixel point in the standard mask image. Usually, the image regions with the grayscale value 1 are set as the unprocessed regions, and the regions with the grayscale value 0 are set to be subjected to the processing of the highest degree. The smaller the grayscale value is, the higher the corresponding processing degree is, and then the standard mask image is established, wherein the level of the processing degree is reflected as the size of a linear fusion coefficient during linear fusion. The specific content of linear fusion between the images based on the linear fusion coefficient is described in the subsequent process, and is not repeated here.

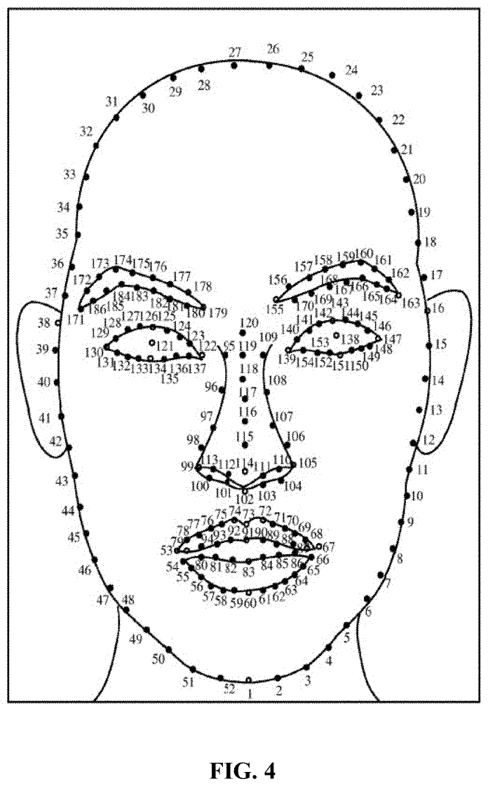

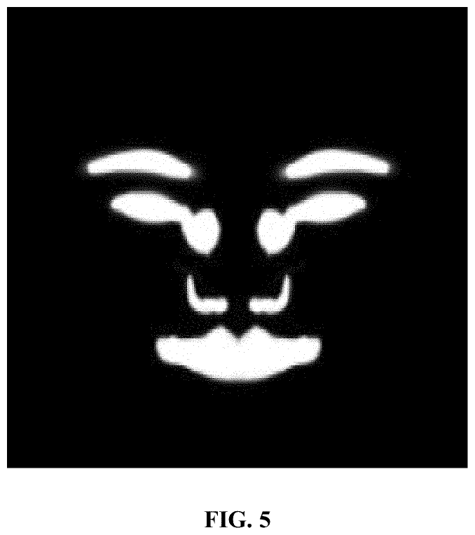

For example, referring to FIG. 4 and FIG. 5, based on the facial feature point recognition model, a standard facial feature point image as shown in FIG. 4 is established in advance, assuming that the eyebrows, eyes, nostrils, lip, and corners of the eyes are taken as an example of the unprocessed regions, the grayscale value of the pixel points of the regions of the eyebrows, eyes, nostrils, lip, and corners of the eyes are set to 1, that is, white regions as shown in FIG. 5, the edge regions of the eyebrows, eyes, nostrils, lip, and corners of the eyes are set as the regions where the grayscale values gradually change from 1 to 0, for example, gradually change from 0.8. 0.7, 0.65 to 0, and then the standard mask image as shown in FIG. 5 is acquired.

Further, the predetermined facial feature point recognition model is adopted to recognize the candidate facial feature points in the human body image to be processed, then the pre-configured standard facial feature point image and the standard mask image are acquired, and based on corresponding relationships between the candidate facial feature points and standard facial feature points, twist mapping is performed on the standard mask image to acquire the second mask image corresponding to the human body image to be processed.

It should be noted that the corresponding relationships between the candidate facial feature points and the standard facial feature points refer to mapping relationships between all candidate facial feature points in the human body image and the standard facial feature points in the standard facial feature point image. For example, in the case that the candidate facial feature point with ID 171 is recognized in the human body image, then the standard facial feature point with ID 171 is found in the standard facial feature point image, and the above candidate facial feature point with ID 171 and the standard facial feature point with ID 171 are a pair of feature points with the mapping relationship. Further, according to the mapping relationship between each pair of feature points, the standard mask image is subjected to twist mapping to acquire the second mask image. In one example, in the second mask image, the grayscale value of the standard facial feature point with ID 171 is configured for the pixel point at the position coordinates indicated by the candidate facial feature point with ID 171.

In some embodiments, after recognizing the candidate facial feature points in the human body image to be processed, the candidate facial feature points are compared with the pre-configured standard facial feature point image to create the mapping relationship between each candidate facial feature point in the human body image and the standard facial feature point in the standard facial feature point image, and then by using the twist mapping mode, the second mask image is acquired by performing twist mapping on the standard mask image based on the mapping relationships.

It should be noted that, in the embodiments of the present disclosure, the standard mask image is acquired after mask coverage is performed on the standard facial feature point image. The second mask image is acquired by mask mapping based on the standard mask image, the second mask image is configured to indicate the processing degrees of different image regions in the human body image to be processed, and the grayscale values of the pixel points in corresponding regions in the first mask image are marked as SkinMask, and the first mask image is generated after the human body image to be processed is detected based on the skin color detection technology. The skin color detection technology can output the probability value of determining whether each pixel point in the image is the skin by image recognition. In the embodiment of the present disclosure, the probability value of the skin color detection technology for each pixel point or each region in the human body image to be processed is taken as the grayscale value of the pixel point or the pixel points in the region to establish the first mask image, the grayscale values of the pixel points in corresponding regions in the second mask image are marked as OrganMask, and the grayscale value of each pixel point in the second mask image is between 0-1.

S2: the initial candidate region in the human body image to be processed is screened based on the first mask image and the second mask image.

Firstly, after the first mask image and the second mask image are determined, the pixel points of which the grayscale values are less than a predetermined first grayscale threshold value in the first mask image are screened as a first type of pixel points, and the pixel points of which the grayscale values are higher than a predetermined second grayscale threshold value in the second mask image are screened as a second type of pixel points.

In other words, the first type of pixel points are screened from the first mask image, and the grayscale values of the first type of pixel points are less than the first grayscale threshold value; and the second type of pixel points are screened from the second mask image, and the grayscale values of the second type of pixel points are higher than the second grayscale threshold value.

Then, a region in the human body image to he processed corresponding to the first type of pixel points is taken as a first specified region, a region in the human body image to be processed corresponding to the second type of pixel points is taken as a second specified region, and then other regions, which do not contain the first specified region and the second specified region, in the human body image to he processed are set as the initial candidate region, wherein the first specified region is the region indicated by the first type of pixel points in the human body image, and the second specified region is the region indicated by the second type of pixel points in the human body image.

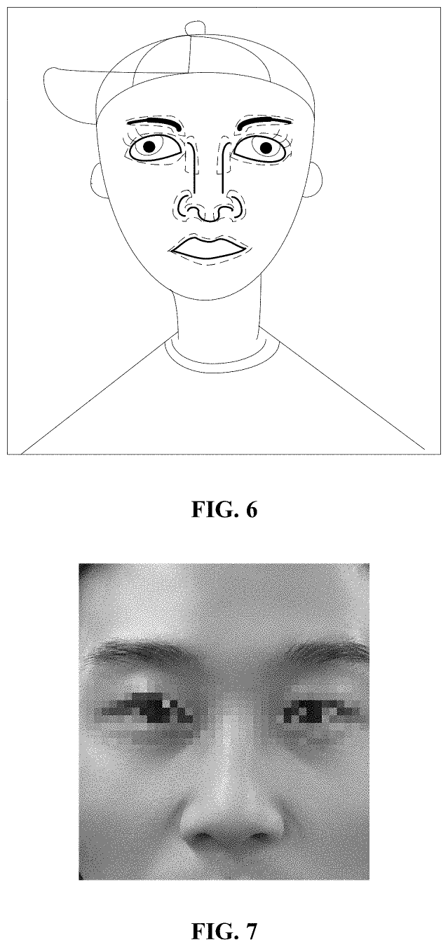

For example, in combination with FIG. 4 to FIG. 6, after facial feature point recognition is performed on the human body image to be processed, based on the standard mask image shown in FIG. 5, the first mask image corresponding to the human body image to be processed is acquired, assuming that the first grayscale threshold value of the pixel points in the first mask image is set to 1, then the first type of pixel points of which the grayscale values are less than 1 in the first mask image are screened, and correspond to the facial region (including the edge regions of facial organs) other than dotted frames in FIG. 6, the second mask image is acquired in combination with the skin color detection technology. The second type of pixel points of which the grayscale values are higher than the predetermined second grayscale threshold value are screened from the second mask image, in the case that the second grayscale threshold value is set to 0, all skin regions including the facial skin and neck skin in FIG. 6 are correspondingly screened, and then respective corresponding distribution regions of the facial region pixel points (i.e., the first type of pixel points) screened from the first mask image and the skin region pixel points (i.e., the second type of pixel points) screened from the second mask image are merged to acquire the initial candidate region in the human body image that needs to be processed.

In this way, based on the actual processing needs, the initial candidate region that needs to be processed in the human body image to be processed can be determined by screening the pixel points in the first mask image and the second mask image, targeted processing of the images of different regions in the human body image to-be-processed can be realized, and due to the screening of the pixel points based on the first mask image and the second mask image, all skin regions other than the facial organs are correspondingly taken as the initial candidate region, which ensures effectiveness and controllability of the image processing.

In S302: a first filtered image is acquired by performing first filter processing on the human body image to be processed, and a first filtered candidate region corresponding to the initial candidate region is determined in the first filtered image, wherein the initial candidate region is a skin region which does not contain a specified region, the specified region being a predetermined region which does not need to be processed.

The captured human body image to be processed is acquired, and the first filter processing is performed on the human body image to be processed to acquire the first filtered image corresponding to the human body image to be processed, in other words, based on the first filtering mode, the human body image is filtered to acquire the first filtered image, wherein the first filtering mode includes, but not limited to, mean filter processing, Gaussian filter processing, guided filter processing, and surface blurring processing, which is not limited by the present disclosure, and not repeated in detail here.

In some embodiments, before the first filter processing is performed on the human body image to be processed, the human body image to be processed is down-sampled based on a specified multiple, then the first filter processing is performed based on the down-sampled human body image to be processed to acquire the first filtered image, and before the human body image to be processed and the first filtered image are processed, the acquired first filtered image is up-sampled based on the specified multiple to acquire an image with the same size as the human body image to be processed.

Further, based on the position of the initial candidate region in the human body image to be processed, the first filtered candidate region in the first filtered image corresponding to the initial candidate region is determined, wherein the first filtered candidate region corresponding to the initial candidate region refers to a first filtered candidate region at a position identical to a position of the initial candidate region. In other words, the position of the first filtered candidate region in the first filtered image is identical to the initial candidate region in the human body image.

For example, assuming that the size of the human body image to be processed is 168×1024, and the predetermined multiple is set to 4 times, then after the human body image to be processed is down-sampled by 4 times, the human body image to be processed is compressed into an image with a size of 42×256, the first filter processing is performed on the 42×256 image to acquire the first filtered image, then the acquired first filtered image with a size of 42×256 is up-sampled by 4 times to be restored to the image with a size of 168×1024, and according to the position of the initial candidate region in the human body image to be processed, the first filtered candidate region at a position identical to a position of the initial candidate region is determined from the first filtered image with a size of 168×1024.

In this way, on one hand, the size of the human body image to be processed is not modified, and the first filter processing is directly performed on all pixel points in the human body image to be processed, which can ensure meticulousness of the image processing. On the other hand, by down-sampling and up-sampling the human body image to be processed, processing time is reduced, real-time image processing is ensured, and the efficiency of image processing is improved at the same time.

In S303: based on grayscale value differences between respective corresponding pixel points in the initial candidate region and the first filtered candidate region, the initial candidate region in the human body image to be processed is divided into a blemished skin region and a non-blemished skin region.

After the initial candidate region in the human body image to be processed and the first filtered candidate region in the first filtered image are determined, based on the grayscale value differences between respective corresponding pixel points in the initial candidate region and the first filtered candidate region, the initial candidate region in the human body image to be processed is divided into the blemished skin region and the non-blemished skin region.

In some embodiments, two pixel points at identical relative positions in the initial candidate region and the first filtered candidate region are taken as a group of pixel points, and the blemished skin region and the non-blemished skin region in the initial candidate region are divided based on the grayscale value differences of respective groups of pixel points. In other words, the initial candidate region is divided into the blemished skin region and the non-blemished skin region based on the grayscale value differences between respective pixel points at identical positions in the initial candidate region and the first filtered candidate region. For example, for each pixel point in the initial candidate region, one pixel point at an identical position can be found in the first filtered candidate region. The grayscale value difference between these two pixel points determines whether the pixel point in the initial candidate region is divided into the blemished skin region or the non-blemished skin region.

The pixel point X existing in the initial candidate region of the human body image to be processed and the pixel point X1 existing in the first filtered candidate region in the first filtered image are taken as examples below for description, wherein the pixel point X and the pixel point X1 respectively have identical position coordinates in the images.

The grayscale value difference between each pair of the pixel point X and the pixel point X1 in the human body image and in the first filtered image is calculated to acquire a difference image. For example, the grayscale difference value between the pixel point X at coordinates (10, 20) in the human body image and the pixel point X1 at coordinates (10, 20) in the first filtered image is calculated to acquire the pixel value of the pixel point X2 at coordinates (10, 20) in the difference image, that is, the pixel value of each pixel point X2 in the difference image records the grayscale value difference between a pair of pixel point X and pixel point X1 at the identical position.

The difference image is marked as DiffImage 1, when it is determined that the pixel value of the pixel point X2 in the DiffImage 1 is less than 0, since the pixel value of the pixel point X2 records the grayscale value difference between the pair of pixel points X and X1, then the pixel point X and the pixel point X1 are marked as a group of blemished pixel points, a blemished mask image is correspondingly set and is marked as DarkMask, and the group of blemished pixel points are set: the grayscale value of the pixel points of the blemished pixel point X and the blemished pixel point X1 at the corresponding positions in the blemished mask image is 1, and the grayscale, value of the pixel points of other positions is set to 0. In other words, after the group of blemished pixel points are marked, in the blemished mask image DarkMask, the grayscale value of the pixel points at positions identical to positions of the group of blemished pixel points are configured as 1, and the above operation is performed on each group of blemished pixel points until all the respective recognized groups of blemished pixel points are traversed.

On the contrary, when it is determined that the pixel value of the pixel point X2 in the Diffimage1 is greater than 0, since the pixel value of the pixel point X2 records the grayscale value difference between the pair of pixel points X and X1, the pixel point X and the pixel point X1 are marked as a group of non-blemished pixel points, a non-blemished mask image is correspondingly set and marked as BrightMask, and the group of non-blemished pixel points are set: the grayscale value of the pixel points of the non-blemished pixel point X and the non-blemished pixel point X1 at the corresponding positions in the non-blemished mask image is 1, and the grayscale value of the pixel points of other positions is 0. In other words, after the group of non-blemished pixel points are marked, in the non-blemished mask image BrightMask, the grayscale value of the pixel points at positions identical to the positions of the group of non-blemished pixel points are configured as 1, and the above operation is performed on each group of non-blemished pixel points until all the respective recognized groups of non-blemished pixel points are traversed.

Further, in the initial candidate region of the human body image to be processed, the region determined by the blemished pixel points is set as the blemished skin region, and the region determined by the non-blemished pixel points is set as the non-blemished skin region. For example, the region indicated by all pixel points with the grayscale value 1 in the blemished mask image DarkMask is determined as the blemished skin region, and the region indicated by all pixel points with the grayscale value 1 in the non-blemished mask image BrightMask is determined as the non-blemished skin region.

It should be noted that for the human body image to be processed, the corresponding facial blemishes such as acnes, stains, and moles in the human body image to be processed are usually represented as the pixel points with lower grayscale values in the grayscale image of the human body image to be processed, while the first filtered image is usually processed as a highly blurred image, that is, the grayscale values of respective pixel points in the first filtered image are approximately the same as and less than the grayscale value of normal skin, and then, by comparing a size relationship of the grayscale values of respective pixel points in the initial candidate region of the human body image to be processed and the grayscale values of the pixel points in the first candidate region of the first filtered image, the initial candidate region of the human body image to be processed is divided into the blemished skin region and the non-blemished skin region.

In S304: a first fusion coefficient of each pixel point in the blemished skin region and the non-blemished skin region is determined, based on the first fusion coefficient, the blemished region and the non-blemished region are respectively linearly fused with corresponding regions in the first filtered candidate region, and the processed blemished region and the processed non-blemished region are merged as the intermediate candidate region in the human body image to be processed.

In other words, in S304, the first fusion coefficient of each pixel point in the blemished skin region and the non-blemished skin region is determined, based on the first fusion coefficient, the blemished skin region and the non-blemished skin region are respectively linearly fused with the corresponding filtered blemished region and the corresponding filtered non-blemished region in the first filtered candidate region to acquire the processed blemished region and the processed non-blemished region, and the processed blemished region and the processed non-blemished region are merged to acquire the intermediate candidate region. The filtered blemished region refers to a region in the first filtered candidate region at a position identical to a position of the blemished skin region, and the filtered non-blemished region refers to a region in the first filtered candidate region at a position identical to a position of the non-blemished skin region.

After the blemished skin region and the non-blemished skin region in the initial candidate region of the human body image to be processed are determined, the first fusion coefficient of each pixel point in the blemished skin region and the non-blemished skin region is respectively determined based on predetermined processing coefficients corresponding to respective pixel points in the initial candidate region, and then based on the first fusion coefficient, the blemished skin region and the non-blemished skin region in the initial candidate region are linearly fused with the first filtered candidate region in the first filtered image.

In other words, the processed blemished region and the processed non-blemished region are acquired by linearly fusing, based on the, first fusion coefficient, the blemished skin region and the non-blemished skin region with the filtered blemished region and the filtered non-blemished region in the first filtered candidate region, respectively.

In some embodiments, based on the first fusion coefficient, the blemished skin region and the filtered blemished region are linearly fused to acquire the processed blemished region; and based on the first fusion coefficient, the non-blemished skin region and the filtered non-blemished region are linearly fused to acquire the processed non-blemished region.

In some embodiments, the process of linearly fusing the blemished region and the non-blemished region with the corresponding regions in the first filtered candidate region in the embodiment of the present disclosure is described by the following two modes:

Mode 1: the acquired human body image to be processed is directly processed.

After the human body image to be processed is acquired, the size of the human body image to be processed is not adjusted, the first filter processing is directly performed on the human body image to be processed to acquire the first filtered image, the first filtered candidate region in the first filtered image corresponding to the initial candidate region in the human body image to be processed is determined, and based on the grayscale values of respective pixel points in the initial candidate region and the first filtered candidate region, the initial candidate region is divided into the blemished skin region and the non-blemished skin region, and then the corresponding blemished mask image and the corresponding non-blemished mask image are determined.

It should be noted that in the embodiment of the present disclosure, since the first filtered image is acquired by performing the first filter processing on the human body image to he processed, the first filtered image and respective pixel points in the human body image to be processed are in one-to-one correspondence, and the first mask image and the second mask image are correspondingly set for the human body image to be processed. The blemished skin region and the non-blemished skin region in the human body image to be processed respectively correspond to the blemished skin mask image and the non-blemished skin mask image. Therefore, among the first filtered image, the human body image to be processed, the first mask image, the second mask image, the blemished mask image, and the non-blemished mask image which have the same size, there is an association between the pixel points with the identical relative positions. The identical relative positions are described as the pixel points with the identical positions relative to a certain fixed reference when different images facing the same direction are placed at the identical position.

In the embodiment of the present disclosure, two pixel points in the blemished skin region and the non-blemished skin region at identical relative positions as the pixel points in the first filtered candidate region are taken as a group of pixel points, in other words, each pixel point in the blemished skin region or the non-blemished skin region and the pixel point at an identical position in the filtered blemished region and the filtered non-blemished region are respectively acquired as a group of pixel points.

In some embodiments, each pixel point in the blemished skin region and the pixel point at the identical position in the filtered blemished region are acquired as a group of pixel points; or each pixel point in the non-blemished skin region and the pixel point at the identical position in the filtered non-blemished region are acquired as a group of pixel points.

A configuration parameter corresponding to a group of pixel points at identical relative positions in the first filtered candidate region and in the blemished skin region is different from a configuration parameter corresponding to a group of pixel points at identical relative positions in the first filtered region and in the non-blemished skin region, that is, the configuration parameter of each group of pixel points associated with the blemished skin region is different from the configuration parameter of each group of pixel points associated with the non-blemished skin region, and the configuration parameters represent a processing degree of the blemished skin region and a processing degree of the non-blemished skin region.

Further, for each group of pixel points, the following operation is respectively performed: a Euclidean distance between a group of pixel points is calculated, and the first fusion coefficient corresponding to the group of pixel points is determined based on the Euclidean distance, the grayscale values of the pixel points in the first mask image corresponding to the group of pixel points, a corresponding processing coefficient of the group of pixel points in the second mask image, and the predetermined configuration parameter, and then the group of pixel points are fused into one pixel point based on the first fusion coefficient. The first mask image is acquired based on skin color detection of the human body image, and the second mask image is acquired based on twist mapping of the standard mask image.

In other words, for each group of pixel points respectively associated with the blemished skin region or the non-blemished skin region, the following operation is performed: the Euclidean distance between two pixel points in each group of pixel points is acquired; the first fusion coefficient of each group of pixel points is determined based on the Euclidean distance, the grayscale values of the pixel points in the first mask image at positions identical to positions of each group of pixel points, the processing coefficient of the pixel points in the second mask image at positions identical to positions of each group of pixel points, and the predetermined configuration parameter of each group of pixel points; then based on the first fusion coefficient of each group of pixel points associated with the blemished skin region, the two pixel points contained in each group of pixel points are fused into one pixel point in the processed blemished region; and based on the first fusion coefficient of each group of pixel points associated with the non-blemished skin region, the two pixel points contained in each group of pixel points are fused into one pixel point in the processed non-blemished region.

Any pixel point Y disposed in the blemished skin region in the initial candidate region and the pixel point Y1 disposed in the filtered blemished region in the first filtered candidate region at the corresponding position identical to the position of the pixel point Y are taken as an example below to describe the process of linearly fusing the pixel point in the blemished skin region and the pixel point in the filtered blemished region in the first filtered candidate region:

FlawImage1=mix(InputImage, BlurImage, min(MixAlpha*DarkMask*a,b));

The FlawImage1 represents the image after the blemished skin region in the human body image is replaced with the processed blemished region. For the above pixel point Y the blemished skin region and the pixel point Y1 in the filtered blemished region, the grayscale value of the pixel point Y2 at the identical position in the processed blemished region in the FlawImage1 is configured as follows: after the pixel point Y and the pixel point Y1 are linearly fused, the grayscale value of the corresponding pixel point Y2 in the intermediate candidate region is acquired.

The InputImage represents the input human body image, and the grayscale value of the pixel point Y existing in the blemished skin region of the human body image to be processed can be queried through the InputImage.

The BlurImage represents the first filtered image, and the grayscale value of the pixel point Y1 disposed in the first filtered candidate region of the first filtered image can be queried through the BlurImage.

The min(MixAlpha*DarkMask*a,b) is the first fusion coefficient of a group of pixel points formed by the pixel point Y and the pixel point Y1, wherein the DarkMask represents the grayscale value, that is, 1, of the pixel point at the position identical to the position of the pixel point Y in the blemished mask image, and a and b are the processing coefficients predetermined for the pixel points of the blemished skin region, and are adjusted according to the actual processing needs. For example, a is 4, b is 0.5, or a and b may also be configured to be any other value greater than 0 by technicians according to business requirements. The MixAlpha is an intermediate processing coefficient, and the calculation process of the MixAlpha is as follows:

MixAlpha=distance(BlurImage, InputImage)*(1.0-OrganMask)*(SkinMask);

The MixAlpha represents a parameter image formed by the intermediate processing coefficient, the BlurImage represents the first filtered image, the InputImage represents the human body image, the distance(BlurImage, InputImage) represents a distance map formed by the Euclidean distance between two pixel points in each group of pixel points, the OrganMask represents the second mask image, and the SkinMask represents the first mask image.

In an example, the grayscale value of the pixel point Y1 is determined in the BlurImage, the grayscale value of the pixel point Y corresponding to the pixel point Y1 in the human body image to be processed is determined in the InputImage, then the Euclidean distance between the pixel points Y and Y1 is determined by the distance(BlurImage, InputImage), then the grayscale values of the pixel points corresponding to the pixel points Y and Y1 in the second mask image are determined in the OrganMask, the grayscale values of the pixel points corresponding to the pixel points Y and Y1 in the first mask image are determined in the SkinMask, and through the calculation mode of the MixAlpha in the above formula, the above respective determined values are calculated to acquire the intermediate processing coefficient of the pixel points corresponding to the pixel points Y and Y1 in the MixAlpha.

Further, after the linear fusion of the pixel point of the blemished skin region in the initial candidate region of the human body image to be processed and the pixel point at the identical position in the filtered blemished region in the first filtered image is completed, the linear fusion operation is performed on the non-blemished skin region in the initial candidate region and the filtered non-blemished region in the first filtered image.

Any pixel point Z disposed in the non-blemished skin region in the initial candidate region and the pixel point Z1 disposed in the filtered non-blemished region in the first filtered candidate region at a corresponding position identical to a position of the pixel point Z are taken as an example below to describe the process of linearly fusing the pixel point in the non-blemished skin region and the pixel point in the filtered non-blemished region in the first filtered candidate region:

FlawImage1′=mix(FlawImage1, BlurImage, min(MixAlpha*BrightMask,0.1));

The FlawImage1 represents the image after the blemished skin region in the human body image is replaced with the processed blemished region. The mode of acquiring the FlawImage1 has been explained in the previous example. Through the FlawImage1, the grayscale value of the corresponding pixel point Z in the human body image to be processed which has been linearly fused with the blemished skin region can be queried.

The BlurImage represents the first filtered image, and the grayscale value of the pixel point Z1 corresponding to the pixel point Z in the first filtered image can be queried through the BlurImage.

The FlawImage1′ represents the image after the blemished skin region and the non-blemished skin region in the human body image are replaced with the processed blemished region and the processed non-blemished region, respectively. Since the blemished skin region and the non-blemished skin region in the human body image form the initial candidate region, the processed blemished region and the processed non-blemished region in the FlawImage1′ are merged to acquire the intermediate candidate region. In other words, the FlawImage1′ represents the image after the initial candidate region in the human body image is replaced with the intermediate candidate region. Through the FlawImage1′, the grayscale value of the pixel point in the non-blemished skin region in the human body image to be processed which has been linearly fused with the blemished region after linear fusion can be queried.

The min(MixAlpha*BrightMask,c) is the first fusion coefficient of a group of pixel points formed by the pixel point Z and the pixel point Z1, wherein the DarkMask represents the grayscale value, that is, 1, of the pixel point at the position identical to the position of the non-blemished pixel point. Z in the non-blemished mask image, and c is the processing coefficient predetermined for the pixel point in the blemished skin region, can be adjusted according to the actual processing needs. For example, the value of c is 0.1, or c may also be configured to be any other value greater than 0 by the technicians according to business requirements. The calculation mode of the MixAlpha is similar to the above calculation mode of the MixAlpha in the blemished skin region, and is not repeated here.

Mode 2: the human body image to be processed is processed by adopting a cooperative processing mode of down-sampling and up-sampling.

After the human body image to be processed is acquired, the human body image to be processed is down-sampled based on a specified multiple to acquire a down-sampled human body image to be processed, the first filter processing is performed on the down-sampled human body image to be processed to acquire the first filtered image, and the first filtered candidate region in the first filtered image corresponding to the initial candidate region in the down-sampled human body image to be processed is determined. Then, based on the grayscale values between respective corresponding pixel points of the first filtered image and the down-sampled human body image to be processed, the blemished skin region and the non-blemished skin region in the down-sampled human body image to be processed are determined, and the corresponding blemished mask image and the corresponding non-blemished mask image are determined.

Further, the acquired blemished mask image, non-blemished mask image, and first filtered image are up-sampled based on the specified multiple to acquire images of the same size as the human body image to be processed.

It should be noted that in the embodiment of the present disclosure, since the first filtered image is acquired by performing the first filter processing on the human body image to be processed, respective pixel points in the first filtered image and in the human body image to be processed are in one-to-one correspondence, and the first mask image and the second mask image are correspondingly set for the human body image to be processed. The blemished skin region and the non-blemished skin region in the human body image to be processed respectively correspond to the blemished mask image and the non-blemished mask image. Therefore, among the first filtered image, the human body image to be processed, the first mask image, the second mask image, the blemished mask image, and the non-blemished mask image which have the same size, there is an association between the pixel points at identical relative positions. The identical relative positions are described as the pixel points at the identical positions relative to a certain fixed reference when different images facing the same direction are placed at the identical position.

In the embodiment of the present disclosure, the two pixel points in the blemished skin region and the non-blemished skin region at identical relative positions as the pixel points in the filtered blemished region and the filtered non-blemished region in the first filtered candidate region are taken as a group of pixel points, wherein the configuration parameter corresponding to a group of pixel points at identical relative positions in the first filtered candidate region and in the blemished skin region is different from the configuration parameter corresponding to a group of pixel points at identical relative positions in the first filtered region and in the non-blemished skin region, and the configuration parameters represent processing degrees of the blemished skin region and the non-blemished skin region. Further, for each group of pixel points, the following operation is respectively performed: a Euclidean distance between a group of pixel points is calculated, and the first fusion coefficient corresponding to the group of pixel points is determined based on the Euclidean distance, the grayscale values of the pixel points in the first mask image corresponding to the group of pixel points, the processing coefficient of pixel points in the second mask image corresponding to the group of pixel points, and the predetermined configuration parameter, and then based on the first fusion coefficient, the group of pixel points are fused into one pixel point.

Further, based on the same processing mode as Mode 1, and based on the first fusion coefficient acquired by calculation, it is realized that the blemished skin region and the non-blemished skin region in the initial candidate region are linearly fused with the filtered blemished region and the filtered non-blemished region in the first filtered candidate region of the first filtered image respectively to acquire the processed blemished region and the processed non-blemished region, which is not repeated here. Then, the processed blemished region and the processed non-blemished region are merged to acquire the intermediate candidate region.

In other words, after the initial candidate region in the human body image is divided into the blemished skin region and the non-blemished skin region, the blemished skin region and the non-blemished skin region are linearly fused with the filtered blemished region and the filtered non-blemished region respectively to acquire the intermediate candidate region.

In this way, the linear fusion of the first filtered region in the first filtered image with the blemished skin region and the non-blemished skin region in the human body image to be processed is realized, since in the embodiment of the present disclosure, the processing coefficients configured for the blemished skin region and the non-blemished skin region are different, appropriate adjustment of the pixel points of the blemished skin region and the non-blemished skin region can be realized, and the increase of the grayscale values of the pixel points with lower grayscale values in the initial candidate region of the human body image to be processed is realized, which is specifically represented by brightening the pixel points in the blemished skin region, and appropriately processing the originally brighter non-blemished skin region in the human body image to be processed. The skin blemished part is usually represented as an obviously darker region, such that through the processing mode of linear fusion, the initial covering processing of the skin blemished part can be realized. At the same time, by using the processing mode of Mode 1, the operation based on the human body image to be processed of the original size can realize detailed processing of the human body image to be processed. By adopting the processing mode of Mode 2, in the process of processing the human body image to be processed, rapid processing of the human body image to be processed can be realized by means of cooperation of the down-sampling and the up-sampling.

In S305: a target candidate region is acquired by performing linear light superimposition processing on the intermediate candidate region based on the grayscale value differences between respective corresponding pixel points in the initial candidate region and the intermediate candidate region, and the human body image to be processed containing the target candidate region is output as a target image.

In other words, in S305, the intermediate candidate region and the initial candidate region are subjected to linear light superimposition to acquire the target candidate region, and then the target image containing the target candidate region is output.

After linear fusion is performed on the initial candidate region in the human body image to be processed and the first filtered candidate region in the first filtered image, the intermediate candidate region in the human body image to be processed is correspondingly acquired. Further, the grayscale values of respective corresponding pixel points in the initial candidate region in the human body image to be processed and the intermediate candidate region in the human body image to be processed are determined respectively, the corresponding pixel points in the initial candidate region in the human body image to be processed and the intermediate candidate region in the human body image to be processed are taken as a group of pixel points, and for each group of pixel points, the following operation is performed respectively: the grayscale value difference between a group of pixel points is determined, and based on the grayscale value difference, linear light superimposition is performed on the intermediate candidate regions in the human body image to be processed. Then, based on the pixel points subjected to the linear light superimposition processing in the intermediate candidate region, the target candidate region in the human body image to be processed is acquired.

That is to say, based on the grayscale value differences between respective pixel points at identical positions in the initial candidate region and the intermediate. candidate region, the linear light superimposition is performed on the intermediate candidate region to acquire the target candidate region.

A group of pixel points, that is, the pixel point M disposed in the initial candidate region in the human body image to be processed and the pixel point Mc disposed in the intermediate candidate region in the human body image to be processed, are taken as an example below for description.

According to the grayscale value of the pixel point M in the initial candidate region in the human body image to be processed, and based on the linear fusion result involved in the above S303, the grayscale value of the pixel point Mc in the intermediate candidate region in the human body image to be processed is determined, the grayscale value difference between the pixel point M and the pixel point Mc is calculated, the above operation is repeated, the grayscale value difference between each group of pixel points is recorded in an image, the image recording the grayscale value differences is marked as DiffImage2, and based on the acquired DiffImage2, the linear light superimposition processing is performed on the pixel point Mc in the intermediate candidate region. The specific implementation formula is as follows:

DiffImage2=FlawImage1′−InputImage+d;

The FlawImage1′ represents the image acquired in the above S304 after the initial candidate region in the human body image is replaced with the intermediate candidate region, and the grayscale value of the pixel point Mc in the intermediate candidate region can be determined through the FlawImage1′.

The InputImage represents the human body image to be processed, and the grayscale value of the pixel point M in the initial candidate region can be determined through the InputImage.

The d is a configured adjustment parameter, and the technicians adjust the value of d according to the actual processing needs, for example, the adaptive value of the d is 0.5, or any other value greater than 0.

The Difflmage2 is the image recording the grayscale difference value between each group of pixel points in the initial candidate region and the intermediate candidate region, and the Difflmage2 is adopted to provide a basic parameter for the linear light superimposition.

Further, based on the above acquired DiffImage2 and FlawImage1′, the processing result Flawlmage2 of linear light superimposition can be determined in the following mode:

FlawImage2=2.0*DiffImage2+FlawImage1′−1.0;

The FlawImage2 represents the grayscale value of the corresponding pixel point in the target candidate region in the human body image to be processed acquired after the linear light superimposition processing is performed on the pixel point Mc. In another expression, the FlawImage2 represents the image after the initial candidate region in the human body image is replaced with the target candidate region, and the target candidate region refers to a processing result after the linear light superimposition is performed on the initial candidate region and the intermediate candidate region.

In some embodiments, the above FlawImage2 is directly output as the target image, or after the above FlawImage2 is further post-processed, the post-processed target image is output.

In this way, based on the grayscale value differences between the pixel points in the intermediate candidate region in the human body image to be processed and the corresponding pixel points in the initial candidate region in the human body image to be processed, the linear light superimposition processing mode is adopted to further adjust the grayscale values of the pixel points in the intermediate candidate region of the human body image to be processed to acquire the human body image to be processed with the blemishes removed.

It should be noted that, in the embodiment of the present disclosure, after the initial candidate region in the human body image to be processed is determined, before the target candidate region in the human body image to be processed is acquired, the human body image to be processed is performed down-sampling processing based on a specified multiple, then second filter processing is performed to acquire a second filtered image corresponding to the human body image to be processed, a second filtered candidate region in the second filtered image corresponding to the initial candidate region in the human body image to be processed is determined, or second filter processing is directly performed on the human body image to be processed to acquire the second filtered image, and the second filtered candidate region in the second filtered image corresponding to the initial candidate region in the human body image to be processed is determined. Further, the linear fusion processing is performed on the second filtered candidate region in the second filtered image and the target candidate region in the human body image to be processed, and the target image which is acquired after completing the processing of the image to be processed and can be output is acquired.

Furthermore, for the human body image to be processed which is down-sampled based on the specified multiple, after the second filter processing is performed to acquire the second filtered image, the acquired second filtered image needs to be adaptively up-sampled based on the specified multiple, such that the second filtered image and the human body image to be processed have the same size, wherein the second filter processing mode includes, but not limited to, guided filter processing, Gaussian filter processing, and the like.

It should be noted that, in the embodiment of the present disclosure, when the second filtered image is acquired based on the human body image to be processed by adopting the guided filter processing, the human body image to be processed is processed as a guide image and an output image, such that the acquired second filtered image has the characteristic of edge-preserving smoothness.

Since the second filtered candidate region in the second filtered image and the target candidate region in the human body image to be processed are acquired based on the same human body image to be processed, the second filtered image and the target candidate region in the human body image to be processed also correspond to the second mask image previously acquired based on the human body image to be processed.

Further, the following formula is adopted to linearly fuse the pixel points in the second filtered candidate region in the second filtered image with the corresponding pixel points in the target candidate region in the human body image to be processed:

OutputImage=mix(flawImage2,GFImage,SkinMask*BlurAlpha);

The OutputImage represents the output target image, and the target image refers to the image acquired by linearly fusing the second filtered image with the human body image containing the target candidate region, that is, the flawImage2, and the target image records the grayscale values of the corresponding pixel points of the target candidate region in the processed human body image to be processed.

The flawImage2 represents the image after the initial candidate region in the human body image is replaced with the target candidate region, and the flawImage2 records the grayscale value of each pixel point in the target candidate region in the human body image to be processed.

The GFImage represents the second filtered image acquired by filtering the human body image, and the second filtered image records the grayscale value of the pixel point in the second filtered image corresponding to a certain pixel point in the human body image.

The SkinMask represents the first mask image acquired by detecting the skin color of the human body image, and the first mask image records the grayscale value of the pixel point in the first mask image corresponding to a certain pixel point in the human body image.

The BlurAlpha is a predetermined adjustable parameter, and the technicians can make adaptive adjustments according to actual needs.

In the above process, after the human body image is filtered to acquire the second filtered image, and skin color detection is performed on the human body image to acquire the first mask image, a second fusion coefficient of each pixel point is determined based on the grayscale values of respective pixel points of the first mask image at positions identical to positions of the pixel points in the human body image containing the target candidate region, then based on the second fusion coefficient, the second filtered image is linearly fused with the human body image containing the target candidate region to acquire the target image, and then the target image is output.

It should be noted that, in actual configuration of the embodiment of the present disclosure, in an application scenario of videos or live streaming, when the acquired human body image to be processed is the image of an anchor or a video interaction user, the skin region and the set organ edge regions of a figure are taken as the initial candidate region, the adjustable parameter BlurAlpha is set to adjust the image, the larger the value of the BlurAlpha is, the better the skin uniformity of the figure in the correspondingly acquired output image is, the smaller the value of the BlurAlpha is, the more the skin texture of the figure in the correspondingly acquired output image is preserved, and the more realistic the image is. For example, the value of the BlurAlpha is 0.3 to ensure the uniformity and realness of the skin.

In this way, the processing result as shown in FIG. 7 can be acquired. In comparison with FIG. 2 and FIG. 7, it can be seen that the solution provided by the present disclosure ensures the skin texture while removing the blemishes in the skin region, such that the acquired image is more realistic. The edge-preserving filtered image can he acquired by using the guided filter, and by linear fusion with the edge-preserving filtered image, unreal smearing can be avoided in the processed target image, and the processed target image is ensured to be attractive and natural.

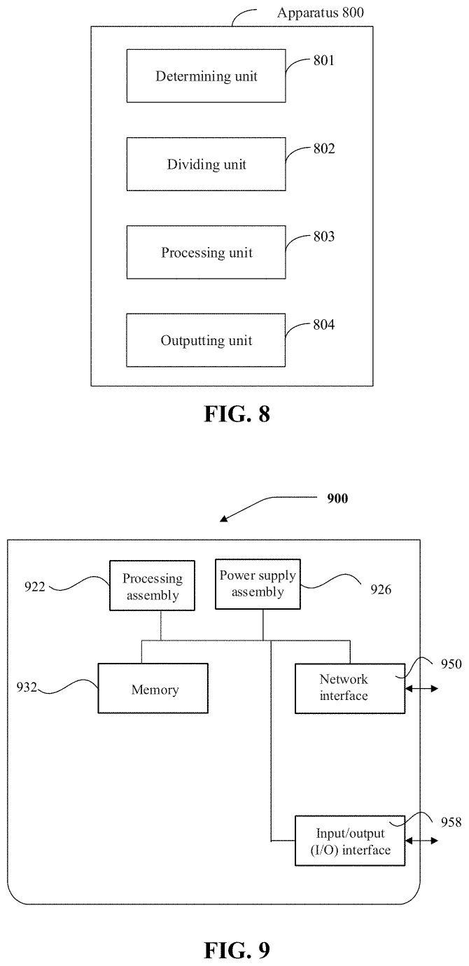

Based on the same inventive concept, referring to FIG. 8, in the embodiment of the present disclosure, an apparatus for processing a human body image 800 at least includes: a determining unit 801, a dividing unit 802, a processing unit 803, and an outputting unit 804.

The determining unit 801 is configured to determine an initial candidate region in the human body image to be processed, acquire a first filtered image by performing first filter processing on the human body image to be processed, and determine a first filtered candidate region in the first filtered image corresponding to the initial candidate region, wherein the initial candidate region is a skin region which does not contain a specified region, and the specified region is a predetermined region which does not need to be processed.

The dividing unit 802 is configured to divide the initial candidate region in the human body image to be processed into a blemished skin region and a non-blemished skin region based on grayscale value differences between respective corresponding pixel points in the initial candidate region and the first filtered candidate region.

The processing unit 803 is configured to determine a first fusion coefficient of each pixel point in the blemished skin region and the non-blemished skin region, respectively linearly fuse the blemished skin region and the non-blemished skin region with corresponding regions in the first filtered candidate region based on the first fusion coefficient, and merge the processed blemished region and the processed non-blemished region as an intermediate candidate region in the human body image to be processed.

In other words, the processing unit 803 is configured to acquire the intermediate candidate region by linearly fusing the blemished skin region and the non-blemished skin region with the filtered blemished region and the filtered non-blemished region, respectively.

The outputting unit 804 is configured to acquire a target candidate region by performing linear light superimposition processing on the intermediate candidate region based on the grayscale value differences between respective corresponding pixel points in the initial candidate region and the intermediate candidate region, and output the human body image to be processed containing the target candidate region as a target image.

In other words, the outputting unit 804 is configured to acquire the target candidate region by performing linear light superimposition on the intermediate candidate region and the initial candidate region; and output the target image containing the target candidate region.

In some embodiments, the determining unit 801 is configured to: acquire a first mask image corresponding to the human body image to be processed by adopting a skin color detection technology, and perform twist mapping on a pre-configured standard mask image to acquire a second mask image corresponding to the human body image to be processed, wherein different grayscale values are configured for pixel points of different regions in the standard mask image, and the different grayscale values represent different predetermined processing coefficients; screen the pixel points of which the grayscale values are less than a predetermined first grayscale threshold value in the first mask image as a first type of pixel points, and screen the pixel points of which the grayscale values are higher than a predetermined second grayscale threshold value in the second mask image as a second type of pixel points; take the region in the human body image to be processed corresponding to the first type of pixel points as a first specified region, and take the region in the human body image to be processed corresponding to the second type of pixel points as a second specified region; and set other regions, which do not contain the first specified region and the second specified region, in the human body image to be processed as the initial candidate region.

In other words, the determining unit 801 is configured to: acquire the first mask image by performing skin color detection on the human body image; acquire the second mask image by performing twist mapping on the standard mask image, different grayscale values being configured for pixel points of different regions in the standard mask image, and different grayscale values representing different processing coefficients; screen the first type of pixel points from the first mask image, grayscale values of the first type of pixel points being less than the first grayscale threshold value; screen the second type of pixel points from the second mask image, grayscale values of the second type of pixel points being higher than the second grayscale threshold value; and set other regions, which do not contain the first specified region and the second specified region, in the human body image as the initial candidate region, the first specified region being a region indicated by the first type of pixel points in the human body image, and the second specified region being a region indicated by the second type of pixel points in the human body image.

In some embodiments, the determining unit 801 is configured to: recognize candidate facial feature points in the human body image to be processed by adopting a predetermined facial feature point recognition model; acquire a pre-configured standard facial feature point image and a standard mask image, and acquire the second mask image corresponding to the human body image to be processed by performing twist mapping on the standard mask image based on corresponding relationships between the candidate facial feature points and standard facial feature points.

In other words, the determining unit 801 is further configured to: recognize the candidate facial feature points in the human body image by using the facial feature point recognition model; acquire the standard facial feature point image and the standard mask image; and acquire the second mask image by performing twist mapping on the standard mask image based on mapping relationships between the candidate facial feature points and the standard facial feature points in the standard facial feature point image.

In some embodiments, the processing unit 803 is further configured to: down-sample the human body image to be processed based on a specified multiple; and up-sample the acquired first filtered image based on the specified multiple.

In some embodiments, the dividing unit 802 is configured to: acquire the first filtered image by filtering the human body image; determine, the first filtered candidate region, at a position identical to a position of the initial candidate region, in the first filtered image; and divide, based on grayscale value differences between respective pixel points at identical positions in the initial candidate region and the first filtered candidate region, the initial candidate region into the blemished skin region and the non-blemished skin region.

In some embodiments, the filtered blemished region refers to a region in the first filtered candidate region at a position identical to a position of the blemished skin region, and the filtered non-blemished region refers to a region in the first filtered candidate region at a position identical to a position of the non-blemished skin region; the processing unit 183 is configured to: determine a first fusion coefficient of each pixel point in the blemished skin region and the non-blemished skin region; acquire the processed blemished region and the processed non-blemished region by linearly fusing, based on the first fusion coefficient, the blemished skin region and the non-blemished skin region with the filtered blemished region and the filtered non-blemished region in the first filtered candidate region respectively; and acquire the intermediate candidate region by merging the processed blemished region and the processed non-blemished region.

In some embodiments, the processing unit 803 is further configured to: respectively determine, based on a predetermined processing coefficient of each pixel point in the initial candidate region, the first fusion coefficient of each pixel point in the blemished skin region and the non-blemished skin region.

In some embodiments, the processing unit 803 is further configured to:

take two pixel points in the blemished skin region and the non-blemished skin region at identical relative positions as the pixel points in the first filtered candidate region as a group of pixel points, in other words, acquire each pixel point in the blemished skin region or the non-blemished skin region and a pixel point at an identical position in the filtered blemished region and the filtered non-blemished region as a group of pixel points respectively, wherein a configuration parameter corresponding to a group of pixel points at identical relative positions in the first filtered candidate region and in the blemished skin region is different from a configuration parameter corresponding to a group of pixel points at identical relative positions in the first filtered region and in the non-blemished skin region, in other words, the configuration parameter of each group of pixel points associated with the blemished skin region is different from the configuration parameter of each group of pixel points associated with the non-blemished skin region, and the configuration parameters represent a processing degree of the blemished skin region and a processing degree of the non-blemished skin region.

For each group of pixel points, the following operation is performed, respectively.

An Euclidean distance between a group of pixel points is calculated, that is, the Euclidean distance between two pixel points in each group of pixel points is acquired; the first fusion coefficient corresponding to the group of pixel points is determined based on the Euclidean distance, the grayscale values of the pixel points in the first mask image corresponding to the group of pixel points, a corresponding processing coefficient of the group of pixel points in the second mask image, and the predetermined configuration parameter, in other words, the first fusion coefficient of each group of pixel points is determined based on the Euclidean distance, the grayscale values of the pixel points in the first mask image at positions identical to positions of each group of pixel points, the processing coefficient of the pixel points in the second mask image at positions identical to positions of each group of pixel points, and the predetermined configuration parameter of each group of pixel points, wherein the first mask image is acquired based on skin color detection of the human body image, and the second mask image is acquired based on twist mapping of the standard mask image.

Based on the first fusion coefficient, the group of pixel points are fused into one pixel point; in other words, based on the first fusion coefficient of each group of pixel points associated with the blemished skin region, the two pixel points contained in each group of pixel points are fused into one pixel point in the processed blemished region; and based on the first fusion coefficient of each group of pixel points associated with the non-blemished skin region, the two pixel points contained in each group of pixel points are fused into one pixel point in the processed non-blemished region.

In some embodiments, the outputting unit 804 is further configured to: determine, based on the grayscale values of respective pixel points in the first mask image corresponding to the human body image to be processed containing the target candidate region, a corresponding second fusion coefficient; linearly fuse, based on the second fusion coefficient, the second filtered image with the human body image containing the target candidate region to acquire the processed human body image to be processed and output the same as a target image.

In some embodiments, the outputting unit 804 is further configured to acquire the target candidate region by performing, based on the grayscale value differences between respective pixel points at identical positions in the initial candidate region and the intermediate candidate region, linear light superimposition on the intermediate candidate region.

In some embodiments, the outputting unit 804 is further configured to: acquire the second filtered image by filtering the human body image; determine, based on grayscale values of respective pixel points of the first mask image at positions identical to positions of pixel points in the human body image containing the target candidate region, the second fusion coefficient of each pixel point, the first mask image being acquired based on the skin color detection of the human body image; acquire the target image by linearly fusing, based on the second fusion coefficient, the second filtered image with the human body image containing the target candidate region; and output the target image.

Based on the same inventive concept, referring to FIG. 9, an apparatus for processing human body image 900 is a server or a terminal device with a processing function. Referring to FIG. 9, the apparatus 900 includes a processing assembly 922, and further includes one or more processors, and a memory resource, represented by a memory 932 and configured to store instructions executable by the processing assembly 922, such as an application program. The application program stored in the memory 932 includes one or more modules, each of which corresponds to a set of instructions. Additionally, the processing assembly 922 is configured to execute the instructions to perform the above method.

The apparatus 900 also includes a power supply assembly 926 configured to execute power management of the apparatus 900, a wired or wireless network interface 950 configured to connect the apparatus 900 to the network, and an input/output (I/O) interface, 958. The apparatus 900 operates based on an operating system stored in the memory 932, such as Windows Server™, Mac OS X™, Unix™, Linux™, FreeBSD™, or similar systems.

Based on the same inventive concept, an embodiment of the present disclosure provides an electronic device based on the embodiments of the method for processing the human body image. The electronic device includes: a memory configured to store one or more executable instructions; and a processor configured to load and execute the executable instructions stored in the memory to perform any method for processing the human body image in the foregoing embodiments.

Based on the same inventive concept, an embodiment of the present disclosure provides a computer-readable storage medium based on the embodiments of the method for processing the human body image, and instructions in the computer-readable storage medium, when executed by an electronic device, cause the electronic device to perform any method for processing the human body image in the foregoing embodiments. The computer-readable storage medium includes, but is not limited to, a magnetic disk memory, a compact disc read-only memory (CD-ROM), an optical memory, and the like.

In summary, in the technical solutions according to the embodiments of the present disclosure, based on the fact that the skin blemishes are usually represented as regions with smaller grayscale values in a grayscale map of the image, the grayscale values of the pixel points in the human body image to be processed are adjusted, real-time removal of the skin blemishes is realized, the texture realness of an image processing result is ensured, the image processing quality is improved, the image processing effect is greatly improved, and real-time processing of the images is realized during live streaming or video shooting.

All the embodiments of the present disclosure can be implemented independently or in combination with other embodiments, which are regarded as the protection scope claimed by the present disclosure.

What is claimed is:

1. A method for processing a human body image, comprising:
dividing an initial candidate region in the human body image into a blemished skin region and a non-blemished skin region, the initial candidate region being a skin region which does not contain a specified region;
acquiring an intermediate candidate region by linearly fusing the blemished skin region and the non-blemished skin region with a filtered blemished region and a filtered non-blemished region respectively;
acquiring a target candidate region by performing linear light superimposition on the intermediate candidate region and the initial candidate region; and
outputting a target image containing the target candidate region.

2. The method according to claim 1, wherein said dividing the initial candidate region in the human body image into the blemished skin region and the non-blemished skin region comprises:
acquiring a first filtered image by filtering the human body image;
determining a first filtered candidate region, at a position identical to a position of the initial candidate region, in the first filtered image; and
dividing, based on grayscale value differences between respective pixel points at identical positions in the initial candidate region and the first filtered candidate region, the initial candidate region into the blemished skin region and the non-blemished skin region.

3. The method according to claim 2, wherein
the filtered blemished region refers to a region in the first filtered candidate region at a position identical to a position of the blemished skin region, and the filtered non-blemished region refers to a region in the first filtered candidate region at a position identical to a position of the non-blemished skin region; and
said acquiring the intermediate candidate region by linearly fusing the blemished skin region and the non-blemished skin region with the filtered blemished region and the filtered non-blemished region respectively comprises:
determining a first fusion coefficient of each pixel point in the blemished skin region and the non-blemished skin region;
acquiring a processed blemished region and a processed non-blemished region by linearly fusing, based on the first fusion coefficient, the blemished skin region and the non-blemished skin region with the filtered blemished region and the filtered non-blemished region in the first filtered candidate region respectively; and
acquiring the intermediate candidate region by merging the processed blemished region and the processed non-blemished region.

4. The method according to claim 3, wherein said determining the first fusion coefficient of each pixel point in the blemished skin region and the non-blemished skin region comprises:
respectively determining, based on a predetermined processing coefficient of each pixel point in the initial candidate region, the first fusion coefficient of each pixel point in the blemished skin region and the non-blemished skin region.

5. The method according to claim 4, wherein said respectively determining, based on the predetermined processing coefficient of each pixel point in the initial candidate region, the first fusion coefficient of each pixel point in the blemished skin region and the non-blemished skin region comprises:
acquiring each pixel point in the blemished skin region or the non-blemished skin region and a pixel point at an identical position in the filtered blemished region or the filtered non-blemished region as a group of pixel points respectively;
acquiring a Euclidean distance between two pixel points in each group of pixel points; and
determining a first fusion coefficient of each group of pixel points based on the Euclidean distance, grayscale values of pixel points in a first mask image at positions identical to positions of each group of pixel points, a processing coefficient of pixel points in a second mask image at positions identical to positions of each group of pixel points, and a predetermined configuration parameter of each group of pixel points, wherein the first mask image is acquired based on skin color detection of the human body image, and the second mask image is acquired based on twist mapping of a standard mask image;
wherein a configuration parameter of each group of pixel points associated with the blemished skin region is different from a configuration parameter of each group of pixel points associated with the non-blemished skin region, and the configuration parameters represent a processing degree of the blemished skin region and a processing degree of the non-blemished skin region.

6. The method according to claim 5, wherein said acquiring the processed blemished region and the processed non-blemished region by linearly fusing, based on the first fusion coefficient, the blemished skin region and the non-blemished skin region with the filtered blemished region and the filtered non-blemished region in the first filtered candidate region respectively comprises:
fusing, based on the first fusion coefficient of each group of pixel points associated with the blemished skin region, the two pixel points contained in each group of pixel points into one pixel point in the processed blemished region; and
fusing, based on the first fusion coefficient of each group of pixel points associated with the non-blemished skin region, the two pixel points contained in each group of pixel points into one pixel point in the processed non-blemished region.

7. The method according to claim 2, further comprising:
down-sampling the human body image based on a specified multiple; and
up-sampling the first filtered image based on the specified multiple.

8. The method according to claim 1, wherein said acquiring the target candidate region by performing linear light superimposition on the intermediate candidate region and the initial candidate region comprises:
acquiring the target candidate region by performing, based on grayscale value differences between respective pixel points at identical positions in the initial candidate region and the intermediate candidate region, linear light superimposition on the intermediate candidate region.

9. The method according to claim 1, further comprising:
acquiring a first mask image by performing skin color detection on the human body image;
acquiring a second mask image by performing twist mapping on a standard mask image, different grayscale values being configured for pixel points in different regions in the standard mask image, and different grayscale values representing different processing coefficients;
screening a first type of pixel points from the first mask image, grayscale values of the first type of pixel points being less than a first grayscale threshold value;
screening a second type of pixel points from the second mask image, grayscale values of the second type of pixel points being higher than a second grayscale threshold value; and
setting other regions, which do not contain a first specified region and a second specified region, in the human body image as the initial candidate region, the first specified region being a region indicated by the first type of pixel points in the human body image, and the second specified region being a region indicated by the second type of pixel points in the human body image.

10. The method according to claim 9, wherein said acquiring the second mask image by performing twist mapping on the standard mask image comprises:
recognizing candidate facial feature points in the human body image by using a facial feature point recognition model;
acquiring a standard facial feature point image and the standard mask image; and
acquiring the second mask image by performing twist mapping on the standard mask image based on mapping relationships between the candidate facial feature points and standard facial feature points in the standard facial feature point image.

11. The method according to claim 1, wherein said outputting the target image containing the target candidate region comprises:
acquiring a second filtered image by filtering the human body image;
determining, based on grayscale values of respective pixel points of a first mask image at positions identical to positions of pixel points in the human body image containing the target candidate region, a second fusion coefficient of each pixel point, the first mask image being acquired based on skin color detection of the human body image;
acquiring the target image by linearly fusing, based on the second fusion coefficient, the second filtered image with the human body image containing the target candidate region; and
outputting the target image.

12. An electronic device, comprising:
a memory configured to store one or more executable instructions; and
a processor configured to load and execute the executable instructions stored in the memory;
wherein the processor, when loading and executing the executable instructions is caused to perform:
dividing an initial candidate region in a human body image into a blemished skin region and a non-blemished skin region, the initial candidate region being a skin region which does not contain a specified region;
acquiring an intermediate candidate region by linearly fusing the blemished skin region and the non-blemished skin region with a filtered blemished region and a filtered non-blemished region respectively;
acquiring a target candidate region by performing linear light superimposition on the intermediate candidate region and the initial candidate region; and
outputting a target image containing the target candidate region.

13. The electronic device according to claim 12, wherein the processor, when loading and executing the executable instructions is caused to perform:
acquiring a first filtered image by filtering the human body image;
determining a first filtered candidate region, at a position identical to a position of the initial candidate region, in the first filtered image; and
dividing, based on grayscale value differences between respective pixel points at identical positions in the initial candidate region and the first filtered candidate region, the initial candidate region into the blemished skin region and the non-blemished skin region.

14. The electronic device according to claim 13, wherein
the filtered blemished region refers to a region in the first filtered candidate region at a position identical to a position of the blemished skin region, and the filtered non-blemished region refers to a region in the first filtered candidate region at a position identical to a position of the non-blemished skin region; and
the processor, when loading and executing the executable instructions is caused to perform:
determining a first fusion coefficient of each pixel point in the blemished skin region and the non-blemished skin region;
acquiring a processed blemished region and a processed non-blemished region by linearly fusing, based on the first fusion coefficient, the blemished skin region and the non-blemished skin region with the filtered blemished region and the filtered non-blemished region in the first filtered candidate region respectively; and
acquiring the intermediate candidate region by merging the processed blemished region and the processed non-blemished region.

15. The electronic device according to claim 14, wherein the processor, when loading and executing the executable instructions is caused to perform:
respectively determining, based on a predetermined processing coefficient of respective pixel points in the initial candidate region, the first fusion coefficient of each pixel point in the blemished skin region and the non-blemished skin region.

16. The electronic device according to claim 15, wherein the processor, when loading and executing the executable instructions is caused to perform:
acquiring each pixel point in the blemished skin region or the non-blemished skin region and a pixel point at an identical position in the filtered blemished region or the filtered non-blemished region as a group of pixel points respectively;
acquiring a Euclidean distance between two pixel points in each group of pixel points; and
determining a first fusion coefficient of each group of pixel points based on the Euclidean distance, grayscale values of pixel points in a first mask image at positions identical to positions of each group of pixel points, a processing coefficient of pixel points in a second mask image at positions identical to positions of each group of pixel points, and a predetermined configuration parameter of each group of pixel points, wherein the first mask image is acquired based on skin color detection of the human body image, and the second mask image is acquired based on twist mapping of a standard mask image;
wherein a configuration parameter of each group of pixel points associated with the blemished skin region is different from a configuration parameter of each group of pixel points associated with the non-blemished skin region, and the configuration parameters represent a processing degree of the blemished skin region and a processing degree of the non-blemished skin region.

17. The electronic device according to claim 16, wherein the processor, when loading and executing the executable instructions is caused to perform:
fusing, based on the first fusion coefficient of each group of pixel points associated with the blemished skin region, the two pixel points contained in each group of pixel points into one pixel point in the processed blemished region; and
fusing, based on the first fusion coefficient of each group of pixel points associated with the non-blemished skin region, the two pixel points contained in each group of pixel points into one pixel point in the processed non-blemished region.

18. The electronic device according to claim 13, wherein the processor, when loading and executing the executable instructions is caused to perform:
down-sampling the human body image based on a specified multiple; and
up-sampling the first filtered image based on the specified multiple.

19. The electronic device according to claim 12, wherein the processor, when loading and executing the executable instructions is caused to perform:
acquiring the target candidate region by performing, based on grayscale value differences between respective pixel points at identical positions in the initial candidate region and the intermediate candidate region, linear light superimposition on the intermediate candidate region.

20. A computer-readable storage medium, wherein one or more instructions in the computer-readable storage medium, when executed by an electronic device, cause the electronic device to perform:
dividing an initial candidate region in a human body image into a blemished skin region and a non-blemished skin region, the initial candidate region being a skin region which does not contain a specified region;
acquiring an intermediate candidate region by linearly fusing the blemished skin region and the non-blemished skin region with a filtered blemished region and a filtered non-blemished region respectively;
acquiring a target candidate region by performing linear light superimposition on the intermediate candidate region and the initial candidate region; and
outputting a target image containing the target candidate region.
